(19) United States
(12) Patent Application Publication
(10) Pub. No.: US 2006/0136810 A1
(43) Pub. Date: Jun. 22, 2006

(54) Electronic form generator

(75) Inventors: Andre Truong, Campbell, CA (US); Vincent Mendicino, Burlingame, CA (US); Shuyuan Chen, Palo Alto, CA (US)

Correspondence Address: KENYON & KENYON LLP, 1500 K STREET N.W., SUITE 700, WASHINGTON, DC, 20005, US

(73) Assignee: SAP Aktiengesellschaft

(21) Appl. No.: 11/052,851

(22) Filed: Feb. 9, 2005

Related U.S. Application Data
(60) Provisional application No. 60/637,762, filed on Dec. 22, 2004.

(51) Int. Cl. G06F 17/00

(52) U.S. Cl. 715/507

(57) ABSTRACT

An automated form generation service within a computer system dynamically creates form templates from a plurality of template documents. For each root node present in a first template document, the service determines whether a matching node is present in a second template and, if so, it merges node structure from corresponding locations within the first and second templates. The form generation service further renders the final electronic form based on available form formats and populates the form with dynamic content. The form generation service is a run-time service that may be called by another requesting application.

### CROSS-REFERENCE TO RELATED APPLICATION

This application claims the benefit of priority afforded by provisional application Ser. No. 60/637,762, filed Dec. 22, 2004.

### BACKGROUND

The present invention relates to a tool that dynamically builds form documents from templates provided to it from requesting applications. Specifically, the tool dynamically assembles form templates, which define form structure, from multiple other template files and also populates form templates with data items provided by the requesting applications.

Modern businesses commonly exchange various form documents as part of their ordinary operations. Forms include documents such as purchase orders, invoices, shipping statements and the like where the documents include a specific kinds of data (e.g., date, purchase order number, line items) are provided in predetermined spatial areas of a document. Not all forms are so regimented. Other documents that might be considered a “form” include firm letterhead documents in which header and footer areas may have a predetermined layout, including a firm logo or address information, but other areas of the document do not have specific structural constructs. Firm letters, press releases and contracts are examples of such forms.

The process of defining firm forms can be a time-consuming task. There are a variety of software tools available on the market which permit an author to define form styles and spatial arrangements that suit the author's needs. Common examples include Microsoft's Word or InfoPath application or the Adobe Form Designer application. Unfortunately, these tools require a form author to become trained on the form design techniques designed for each application. Further, the applications permit an author to define only one form at a time. Thus, work done to prepare a first form is not reusable during preparation of a second form. Further, such forms are not amenable for use with automated software applications, where the applications can define form structure and provide content for the forms in real time.

Accordingly, there is a need for a tool that defines form structures dynamically, during a run time environment of a calling application. Further, there is a need for such a tool that both builds form structure and populates the forms during run time. Finally, there is a need in the art for a tool that can render a populated form in any of a number of file formats and even can re-render a form in an alternate file format if a first file format ultimately proves to be inappropriate for a recipient's use.

### BRIEF DESCRIPTION OF THE DRAWINGS

FIG. 1 is a data flow diagram illustrating creation of an electronic form according to an embodiment of the present invention.

FIG. 2 is a functional block diagram of a form generator service in a computer system.

FIG. 3 is a method diagram according to an embodiment of the present invention.

FIG. 4 is a data flow diagram illustrating creation of an electronic form according to another embodiment of the present invention.

FIG. 5 is a block diagram of a computer system.

### DETAILED DESCRIPTION

Embodiments of the present invention provide an automated form generation service within a computer system that dynamically creates form templates from a plurality of template documents. The form generation service further may populate the form with dynamic content. The form generation service is a runtime service that may be called by another requesting application. Accordingly, efforts to design forms manually during application configuration time or runtime can be avoided.

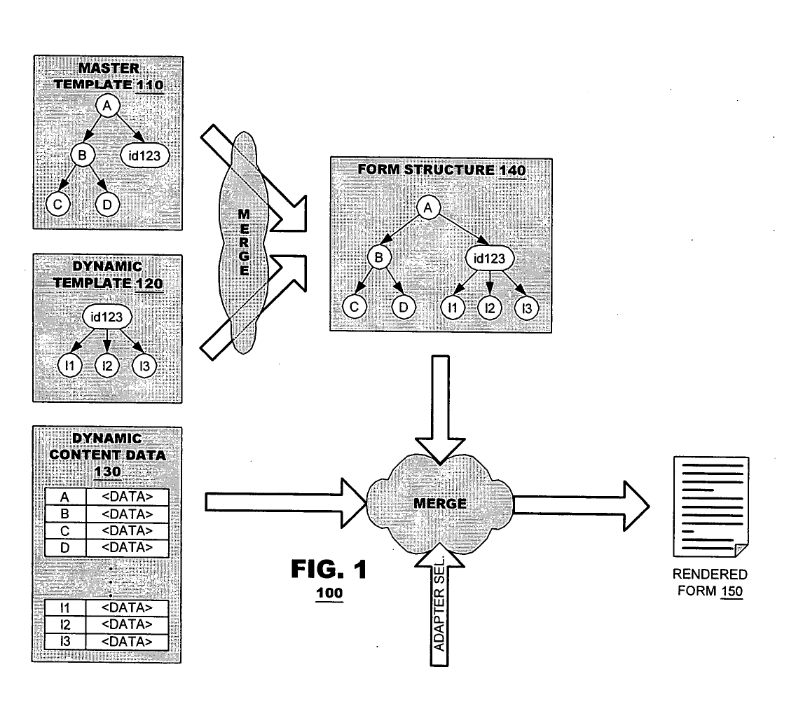

FIG. 1 is a data flow diagram illustrating creation of an electronic form according to an embodiment of the present invention. According to the embodiment, an electronic form may be constructed from as many as three items of source data: a master form template 110, a dynamic form template 120 and dynamic content data 130. The master form template 110 defines base form structure and may include layout and/or content data that typically is re-used across multiple forms. The dynamic form template 120 defines additional form structure that typically is unique to the form being created. The dynamic content data 130 includes data that populates various fields defined in the master form template and/or the dynamic form template. The scope and content of these three elements may vary according to different uses for which the electronic form generator may be used.

FIG. 1 illustrates exemplary data structures for the master form template 110 and the dynamic form template 120. The master form template 110 is illustrated as a hierarchy of nodes. Each node may represent various form elements and sub-elements and include layout data for each. For example, companies often provide consistent layout definitions for a firm logo, address information and footer data for their forms, regardless of the type of form being used. Such information may be provided in a master form template 110.

FIG. 1 also illustrates an exemplary data structure for the dynamic form template 120. The dynamic form template also is illustrated as a hierarchy of nodes. Each node may represent various form elements and sub-elements and include layout data for each. The dynamic template, for example, may include sufficient structural definitions to distinguish a firm's invoice from its purchase order from other definitional elements. The dynamic form template 120 may include one or more root nodes, each of which may be labeled in a header thereof. Only one root node (id123) is illustrated in the example of FIG. 1.

According to an embodiment of the present invention, the form generator may generate a completed form template 140 from a merger of the master form template 110 and the dynamic form template 120. Root nodes from the dynamic form template 120 are compared to nodes from the master form template. If a match occurs, the corresponding node structure may be integrated with the master template node structure at the point where a match occurs. In the example illustrated in FIG. 1, the root node “id123” from the dynamic form template 120 matches a corresponding node in the master form template structure occurring immediately below the A node. The id123 node and child nodes I1-I3 may be merged to a corresponding location in the master template node structure, which yields structure illustrated for the completed form template 140.

Although the dynamic form template illustrates only a single node structure, the principles of the present invention may be extended to dynamic form templates in which multiple node structures are present. In such a case, there may be several root nodes defined therein. A comparison of each root node in the dynamic form template 120 may be made against nodes defined in the master form template 110 and, when matches occur, the corresponding node structures may be integrated as described above. Optionally, if no match occurs, the node structure(s) of the dynamic form template may be appended to the root node of master template.

Having assembled the rendered form structure 140, the form generation process may construct a rendered form 150 by populating form elements with dynamic content data 130. The dynamic content data 130 may include field labels, which correspond to some or all of the data elements defined in the node hierarchy of the form structure 140, and corresponding data to be used with those field labels. FIG. 1 illustrates a simple case where the dynamic content data 130 provides data for every node in the form structure 140. Of course, this will not occur in every instance of the invention. As explained above, a master template may define various elements such firm logos, address information and footer data. Content for such element also might be provided in the master form template 110 instead of the dynamic content data 130.

According to an embodiment, the rendered form 150 may be rendered in a format as specified by a calling requestor. Typically, an adapter will be available for each of a predetermined number of formats, such as PDF forms, InfoPath forms, HTML forms and the like. To render the rendered form 150 in a desired format, it is sufficient simply to call an appropriate adapter. The rendered form 150 may be output from the form generator system to storage or to a communication system (not shown) for delivery to its ultimate recipient.

As the foregoing description demonstrates, the form generator process can dynamically assemble form structure and form content during a run time operation in a computer system. These embodiments of the present invention, therefore, can omit manual form definition steps which characterize prior form definition systems.

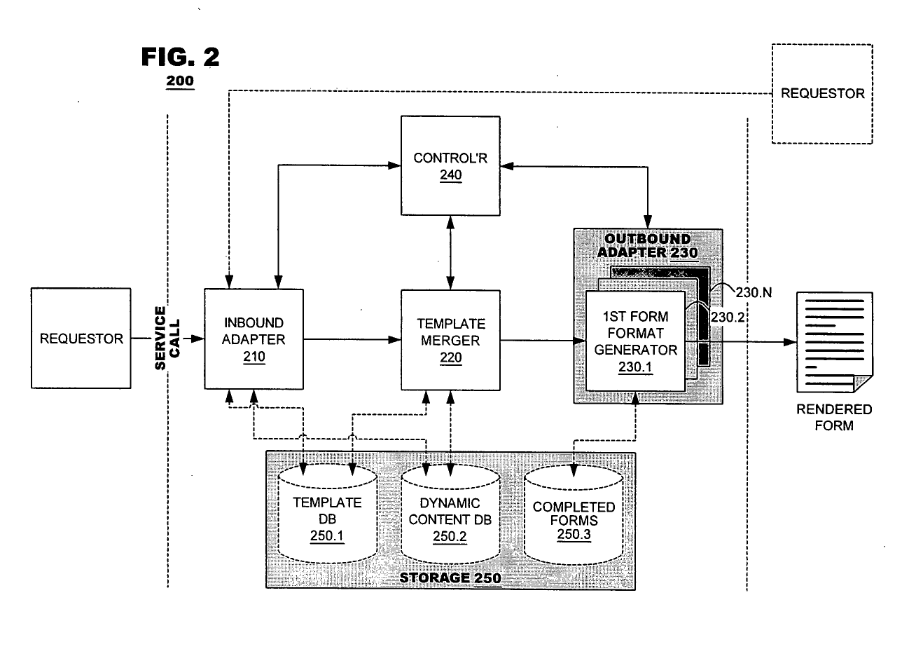

FIG. 2 is a functional block diagram of a form generator 200 according to an embodiment of the present invention. The form generator 200 may be embodied as program module running on a computer platform such as a personal computer, server and the like. The form generator 200 may include an inbound adapter 210, a template merger unit 220, an outbound adapter 230 and a generator controller 240. Each of these elements may be provided as corresponding functional components in a software driven computer system. The inbound adapter 210 receives runtime calls from other modules within the computer system to generate forms. These calls may include the master and dynamic templates themselves or pointers to locations within a file system where the templates reside. The template merger unit 220 may generate the rendered form from the input templates according to an internal representation of the template. Finally, the outbound adapter 230 may generate an electronic form in the format identified by the service call, integrating the dynamic content data into the completed template.

The form generator 200 may interface with various other software modules within a computer system. For example, in the context of enterprise management software systems, the form generator 200 may be provided in communication with contract management systems, billing system, marketing campaign systems, support and feedback systems, customer interaction systems and the like (represented as a “requester” in FIG. 2). The inbound interface 210 fields service calls from these applications to build forms.

The outbound adapter 230 may include multiple translation services to render the form in a specified file format. The file format to be output from the form generator 200 is specified in the service call. For example, it may be set expressly in the call request itself or, if the system operates according to a default file format, it may be set expressly only when it is desired to overrule the default settings. Upon receipt of a completed form structure from the merger unit 220, the outbound adapter invokes one of the format generators (e.g., 230.1) to render the form in the specified format. Thereafter, the electronic form may be output from the form generator 200.

Optionally, in another embodiment, the form generator 200 may include dedicated storage 250 for master and dynamic template objects 250.1, for dynamic content objects 250.2 and for rendered forms 250.3. By providing persistent storage for such items, such items need not be imported from a requesting agent anew for each service call where they are referenced. For example, when posting mass-produced invoices during a billing cycle, master form templates and dynamic form templates might be identical across several hundred batches of invoices. In such as case, it could be inefficient for the form generator 200 to import these data objects from the requestor's data store for every batch. These data items may be stored in the form generator's storage 250 for ready use.

Additionally, by storing completed form templates and dynamic content data in storage 250, the form generator may respond to requests from recipients of rendered forms for copies of the form in alternative format. Hypothetically, assume that a given form was rendered in PDF format according to an initial service request but ultimately that format was inappropriate for use by its recipient. In such a case, the form generator 200 may re-render the form in the alternate format by retrieving the completed templates and dynamic content data from its own storage 250 without requiring access to the requestor's data store.

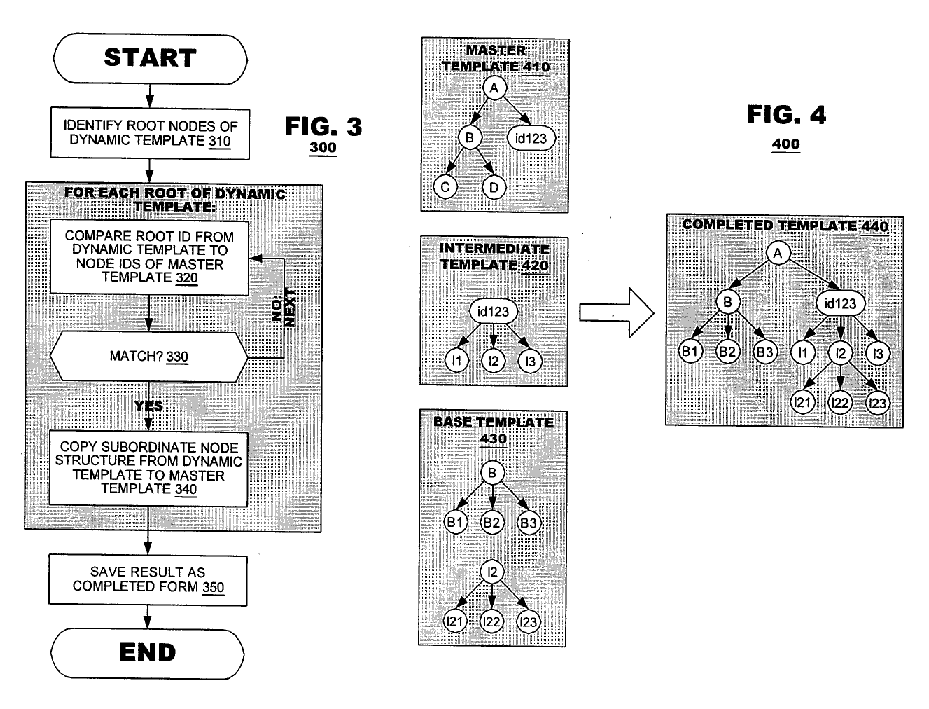

FIG. 3 illustrates a method 300 according to an embodiment of the present invention. The method may survey a dynamic template to identify root node(s) defined therein (box 310). For each root note, the method 300 may compare an identifier of the root note against node identifiers within the master template (box 320). If a match occurs (box 330), the method 300 may merge a node structure under the root node from the dynamic template with that of the master template (box 340). If a match does not occur (box 330), the method 300 may add or append a node structure under the root node from the dynamic template to the master template. When the last iteration is completed, the resultant form structure may be saved as a completed form template (box 350).

As indicated, the operations of the foregoing embodiments may be extended to dynamic templates that include multiple root nodes. The present invention also extends to applications where there may be multiple template documents. One such example is illustrated in the flow diagram of FIG. 4.

FIG. 4 illustrates data flow from among three different template documents—a master template 410, an intermediate template 420 and a base template 430. In this embodiment, the base template 430 includes root nodes labeled “B” and “I2.” Again, nodes of the base template 430 may include header data (not shown) that labels the node. In one embodiment, node header data may also include pointers to intermediate templates (such as template 420) to which they relate.

In this option, a completed template 440 may be generated from the master template 410, the intermediate template 420 and the base template 430. For example, the form generator may review root nodes of the base template 430 and compare them against node structures of the master and intermediate templates 410, 420, merging node structures where appropriate. In one embodiment, a node structure from the master template may be overwritten (or supplemented) by a node structure from a base template 430 where a matching node in the master template has subordinate node structure.

Operation of the method is recursive, root nodes of the intermediate template may be compared to nodes of the master template and node structures may be merged or added to the completed form template where appropriate. At the end of the recursive process, the completed template 440 may be generated as shown in FIG. 4.

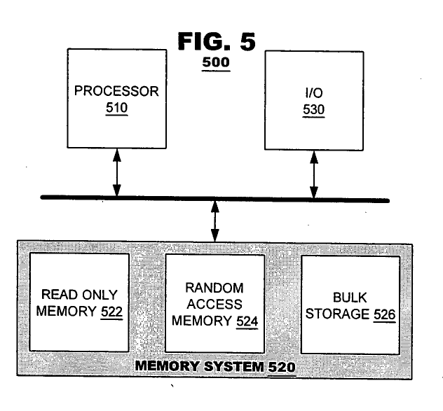

The processes of the foregoing embodiments may be performed by any number of processor based systems, such as computers, servers and mobile devices. FIG. 5 is a simplified block diagram of a processor system 500 that may be useful for practice of the present invention. There, the processor system 500 is shown as being populated by a processor 510, a memory system 520 and an input/output (I/O) unit 530. The processor 510 may be any of a plurality of conventional processing systems, including microprocessors, digital signal processors and field programmable logic arrays. In some applications, it may be advantageous to provide multiple processors (not shown) in the server 500. The processor(s) 510 execute program instructions stored in the memory system. The memory system 520 may include any combination of conventional memory circuits, including electrical, magnetic or optical memory systems. As shown in FIG. 5, the memory system 520 may include read only memories 522, random access memories 524 and bulk storage 526. The memory system 520 not only stores the program instructions representing the various methods described herein but also can store the data items on which these methods operate. The I/O unit 530 permits communication with external devices (not shown), for example other computers or servers.

Several embodiments of the present invention are specifically illustrated and described herein. However, it will be appreciated that modifications and variations of the present invention are covered by the above teachings and within the purview of the appended claims without departing from the spirit and intended scope of the invention.

What is claimed is:

1. A form generation method, comprising:
responsive to a call identifying a master form template and a dynamic form template, comparing identifiers of root nodes within the dynamic form template to data items within the master form template,
when a match occurs, merging the root node with sub-ordinate data structures from the dynamic form template to a position within the master form template where the match occurred, and
storing a resultant structure as a completed form template.

2. The form generation method of claim 1, further comprising generating a rendered form from the completed form template and a dynamic content data item, wherein the rendered form includes data from the dynamic content data item at form positions in the completed form template according to metadata identifiers included in each.

3. The form generation method of claim 0, further comprising rendering the rendered form in a file format specified in the call.

4. The form generation method of claim 0, further comprising rendering the rendered form in a default file format unless another file format is specified in the call.

5. The form generation method of claim 0, further wherein the completed form template is stored in persistent storage dedicated for use by a form generator service.

6. A form generation method, comprising:
responsive to a call identifying a master form template, a dynamic form template, multiple instances of dynamic content data and a file format, comparing identifiers of root nodes within the dynamic form template to data items within the master form template,
when a match occurs, creating a completed form template by merging the root node with data structures from the dynamic form template to a position within the master form template where the match occurred,
generating multiple instances of rendered forms from the completed form template and respective instances of the dynamic content data, wherein the rendered form includes data from the dynamic content data item at form positions in the completed form template according to metadata identifiers included in each, and
rendering the rendered form in a file format specified in the call.

7. The form generation method of claim 6, further comprising storing the completed form template in storage allocated for performance of the method.

8. The form generation method of claim 7, wherein the generating includes, for each instance of rendered form, retrieving the completed form template from storage.

9. A form generator service, comprising:
an inbound adapter, responsive to service calls from requesters that identify a master template, a dynamic template and dynamic form content data,
a merger unit that generates a completed form template from a merger of master template data and dynamic template data, and
an outbound adapter that generates a rendered form from the completed form template and the dynamic form content data in a selected file format.

10. The form generator service of claim 9, wherein the selected file format is specified in the service call.

11. The form generator service of claim 9, wherein the selected file format is a default file format unless specified in the service call.

12. The form generator service of claim 9, further comprising persistent storage dedicated for storage of the master template and the dynamic template data.

13. The form generator service of claim 9, further comprising persistent storage dedicated for storage of the dynamic content data.

14. The form generator service of claim 9, wherein the service call includes pointers to the master template data and the dynamic template data in the requestor's file system.

15. The form generator service of claim 9, wherein the merger unit:
compare identifiers of root nodes within the dynamic form template to data items within the master form template, and
when a match occurs, creates a completed form template by merging the root node with sub-ordinate data structures from the dynamic form template to a position within the master form template where the match occurred.

16. A computer readable medium storing program instructions that, when executed, invoke an instance of a form generator that:
in response to a call identifies a master form template and a dynamic form template, compare identifiers of root nodes within the dynamic form template to data items within the master form template,
when a match occurs, merges the root node and sub-ordinate data structures from the dynamic form template where the match occurred, and
stores resultant structure as a completed form template.

17. The medium of claim 16, wherein the instructions further cause the form generator to generate a rendered form from the completed form template and a dynamic content data item, wherein the rendered form includes data from the dynamic content data item at form positions in the completed form template according to metadata identifiers included in each.

18. The medium of claim 17, wherein the instructions further cause the form generator to generate the rendered form in a file format specified in the call.

19. The medium of claim 17, wherein the instructions further cause the form generator to generate the rendered form in a default file format unless another file format is specified in the call.

20. The medium of claim 17, wherein the instructions further cause the form generator to store the completed form template in persistent storage dedicated for use by the form generator.
